(19) United States
(12) Patent Application Publication
(10) Pub. No.: US 2014/0304045 A1
(43) Pub. Date: Oct. 9, 2014

(54) METHOD AND APPARATUS FOR SELECTING INCENTIVE TARGET USERS

(71) Applicant: TENCENT TECHNOLOGY (SHENZHEN) COMPANY LIMITED, Shenzhen (CN)

(72) Inventor: WOHUA WANG, Shenzhen (CN)

(73) Assignee: TENCENT TECHNOLOGY (SHENZHEN) COMPANY LIMITED, Shenzhen (CN)

(21) Appl. No.: 14/311,828

(22) Filed: Jun. 23, 2014

Related U.S. Application Data
(63) Continuation of application No. PCT/CN2013/090968, filed on Dec. 30, 2013.

(30) Foreign Application Priority Data
Dec. 27, 2012 (CN) 201210578333.3

(51) Int. Cl. G06Q 30/02

(52) U.S. Cl. CPC G06Q 30/0207
USPC 705/14.1

(57) ABSTRACT

A method is provided for selecting incentive target users. The method includes a server configuring multiple incentive conditions based on preset rules. The method also includes the server selecting incentive conditions from multiple incentive conditions based on a first configuration instruction and forming multiple incentive sets by performing a logical combination of the selected incentive conditions. Further, the method includes the server selecting incentive sets from multiple incentive sets based on a second configuration instruction and forming an incentive program by performing a logical combination of the selected incentive sets. The method includes the server receiving user information of multiple user groups sent from a user terminal and selecting users whose information meets at least one incentive set included in the incentive program as incentive target users.

### CROSS-REFERENCES TO RELATED APPLICATIONS

This application is a continuation application of PCT Patent Application No. PCT/CN2013/090968, filed on Dec. 30, 2013, which claims priority of Chinese Patent Application No. 201210578333.3, filed on Dec. 27, 2012, the entire contents of which are incorporated by reference herein.

### FIELD OF THE INVENTION

The present invention generally relates to Internet technologies and, more particularly, to a method and apparatus for selecting incentive target users.

### BACKGROUND

With the rapid development of network technologies, network applications are becoming more and more popular. Selection of incentive target users, like the user lottery system selects winners, is widely applied in the network. Selection of incentive target users refers to the selection of one or more incentive target users from a specific group of users. The incentive target users are given certain incentives, such as prizes, points, or preferential conditions. In the current incentive program generation system, network technicians need to write codes to create incentive programs, and different incentive programs are created for the different user groups.

In practical applications, because there are multiple user groups, the network technicians need to write codes according to different user groups, respectively. That is, for each user group, network technicians need to write codes to develop a specific incentive system. Every time a new user group with specific properties is defined, a new incentive system needs to be developed. This requires network technicians to re-write the codes, thus affecting the efficiency of website operations and maintenance, as well as increasing maintenance costs and risks. The generation cycle of incentive system is longer, and the cost of implementation is higher.

The disclosed methods and apparatus are directed to solve one or more problems set forth above and other problems.

### BRIEF SUMMARY OF THE DISCLOSURE

One aspect of the present disclosure includes a method for selecting incentive target users. The method includes a server configuring multiple incentive conditions based on preset rules. The method also includes the server selecting incentive conditions from multiple incentive conditions based on a first configuration instruction and forming multiple incentive sets by performing a logical combination of the selected incentive conditions. Further, the method includes the server selecting incentive sets from multiple incentive sets based on a second configuration instruction and forming an incentive program by performing a logical combination of the selected incentive sets. The method includes the server receiving user information of multiple user groups sent from a user terminal and selecting users whose information meets at least one incentive set included in the incentive program as incentive target users.

Another aspect of the present disclosure includes an apparatus for selecting incentive target users. The server includes a configuration unit, a first forming unit, a second forming unit, and a first selection unit. The configuration unit is configured to configure multiple incentive conditions based on preset rules. The first forming unit is configured to select incentive conditions from multiple incentive conditions based on a first configuration instruction and to form multiple incentive sets by performing a logical combination of the selected incentive conditions. The second forming unit is configured to select incentive sets from multiple incentive sets based on a second configuration instruction and to form an incentive program by performing a logical combination of the selected incentive sets. The first selection unit is configured to receive user information of multiple user groups sent from a user terminal and to select the users whose information meets the incentive conditions included in at least one incentive set as incentive target users.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions of the present invention or the existing technology, the figures which are needed to be used in the description of the present invention or the existing technology are briefly described in the following. Obviously, the figures in the following description are only some embodiments of the present invention, and it is easily for those skilled in the art to obtain other figures based on the following figures without creative work.

FIG. 1 illustrates a flow diagram of an exemplary method for selecting incentive target users consistent with the disclosed embodiments;

FIG. 2 illustrates a flow diagram of another exemplary method for selecting incentive target users consistent with the disclosed embodiments;

FIG. 3 illustrates a schematic diagram of an exemplary select box consistent with the disclosed embodiments;

FIG. 4 illustrates a schematic diagram of an exemplary edit box consistent with the disclosed embodiments;

FIG. 5 illustrates a schematic diagram of another exemplary edit box consistent with the disclosed embodiments;

FIG. 6 illustrates an exemplary method for selecting incentive target users for an application consistent with the disclosed embodiments;

FIG. 7 illustrates a structure diagram of an exemplary server consistent with the disclosed embodiments;

FIG. 8 illustrates a structure diagram of another exemplary server consistent with the disclosed embodiments;

FIG. 9 illustrates an exemplary operating environment incorporating certain disclosed embodiments; and

FIG. 10 illustrates a block diagram of an exemplary computer system consistent with the disclosed embodiments.

### DETAILED DESCRIPTION

Reference will now be made in detail to exemplary embodiments of the invention, which are illustrated in the accompanying drawings.

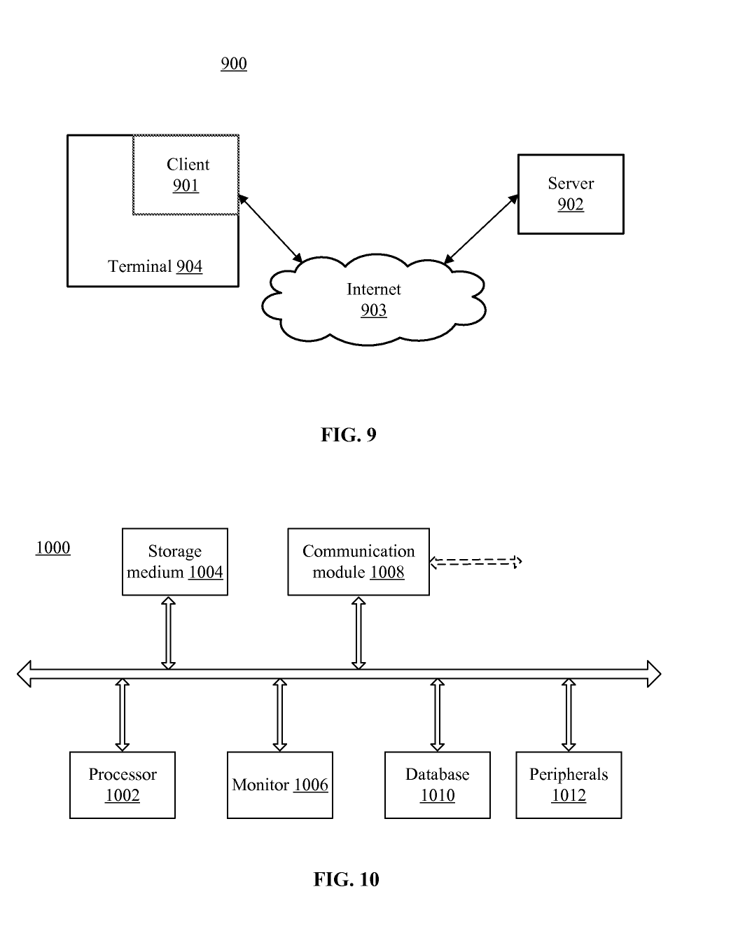

FIG. 9 illustrates an exemplary operating environment 900 incorporating certain disclosed embodiments. As shown in FIG. 9, environment 900 may include a terminal 904, the Internet 903, and a server 902. The Internet 903 may include any appropriate type of communication network for providing network connections to the terminal 904 and the server 902 or among multiple terminals and servers. For example, Internet 903 may include the Internet or other types of computer networks or telecommunication networks, either wired or wireless.

A server, as used herein, may refer to one or more server computers configured to provide certain web server functionalities to provide certain personalized services, which may require any user accessing the services to authenticate to the server before the access. A web server may also include one or more processors to execute computer programs in parallel.

The server 902 may include any appropriate server computers configured to provide certain server functionalities, such as functionality for responding a user's request for selecting incentive target users or other application server. Although only one server is shown, any number of servers can be included. The server 902 may be operated in a cloud or non-cloud computing environment.

Terminal 904 may include any appropriate type of mobile computing devices, such as mobile phones, smart phones, tablets, notebook computers, or any type of computing platform. A terminal (e.g., terminal 904) may include one or more clients 901. The client 901, as used herein, may include any appropriate mobile application software, hardware, or a combination of application software and hardware to achieve certain client functionalities. For example, client 901 may include a browser, etc. According to actual needs in different terminals, a mobile client may be a browser installed on the terminal for browsing, including various types of existing and future browser installed on terminals. Although only one client 901 is shown in the environment 900, any number of clients 901 may be included.

Terminal 904, client 901, and/or server 902 may be implemented on any appropriate computing platform. FIG. 10 illustrates a block diagram of an exemplary computer system 1000 capable of implementing terminal 904, client 901, and/or server 902.

As shown in FIG. 10, computer system 1000 may include a processor 1002, a storage medium 1004, a monitor 1006, a communication module 1008, a database 1010, and peripherals 1012. Certain devices may be omitted and other devices may be included.

Processor 1002 may include any appropriate processor or processors. Further, processor 1002 can include multiple cores for multi-thread or parallel processing. Storage medium 1004 may include memory modules, such as Read-only memory (ROM), Random Access Memory (RAM), flash memory modules, and erasable and rewritable memory, and mass storages, such as CD-ROM, Flash disk, hard disk, etc. Storage medium 1004 may store computer programs for implementing various processes, when executed by processor 1002.

Further, peripherals 1012 may include I/O devices such as keyboard and mouse, and communication module 1008 may include network devices for establishing connections through the communication network. Database 1010 may include one or more databases for storing certain data and for performing certain operations on the stored data, such as database searching.

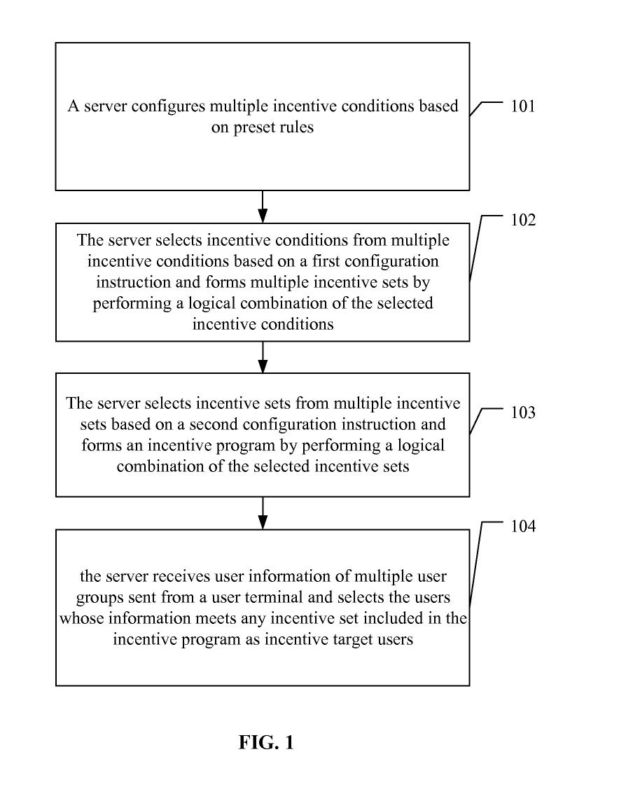

In operation, terminals/clients and servers 902 may interact with each other to provide a service for selecting incentive target users to the user(s) of the terminals. The server may be provided to select incentive target users. FIG. 1 illustrates a flow diagram of an exemplary selection method for motivating target users consistent with the disclosed embodiments.

As shown in FIG. 1, the method for selecting incentive target users includes the following steps.

Step 101: a server configures multiple incentive conditions based on preset rules.

Optionally, the incentive conditions may be configured based on the actual needs of a service provider. The incentive conditions can promote the service provider growth and development, such as user performance, user efficiency, etc.

Step 102: the server selects incentive conditions from multiple incentive conditions based on a first configuration instruction and forms multiple incentive sets by performing logical combinations of the selected incentive conditions.

Optionally, the number of incentive conditions included in any of the incentive sets may be one or more. Any of the incentive sets can be considered as a complete incentive program. As long as the user information meets the incentive conditions in any of the incentive sets, the user is selected as the incentive target user. Meanwhile, each incentive set can be specific to one user group.

Step 103: the server selects incentive sets from multiple incentive sets based on a second configuration instruction and forms an incentive program by performing logical combinations of the selected incentive sets. Optionally, the number of the incentive set included in the incentive program may be more than one.

Step 104: the server receives user information of multiple user groups sent a user terminal and selects the users whose information meets any incentive set included in the incentive program as incentive target users. Optionally, the number of the user terminal may be more than one, and the incentive target users may be selected when the user information meets all of the incentive sets in the incentive program.

Optionally, at least one incentive set forms an incentive program. The server may use the incentive program to select incentive target users for at least one user group. The selected users whose information meets the incentive conditions included in any of the above incentive sets are selected as the incentive target users. The selected user can be multiple users or a single user.

Thus, a server configures multiple incentive conditions based on preset rules. The server selects incentive conditions from multiple incentive conditions based on a first configuration instruction and forms multiple incentive sets by performing a logical combination of the selected incentive conditions. The server selects incentive sets from multiple incentive sets based on a second configuration instruction and forms an incentive program by performing a logical combination of the selected incentive sets. The server receives user information of multiple user groups sent from a user terminal and selects the users whose information meets any incentive set included in the incentive program as incentive target users. Thus, it is no longer required that network technicians to re-write codes for each user group, reducing incentive systems generation cycle and keeping implementation cost low.

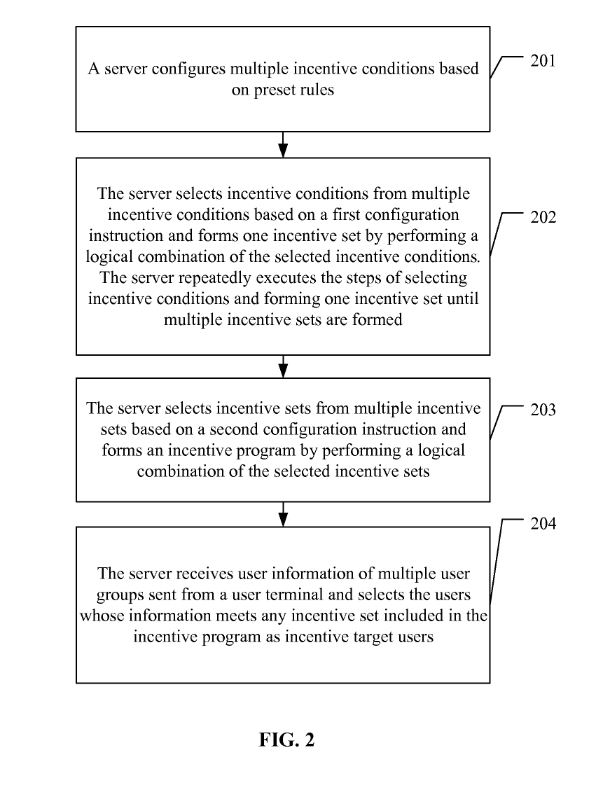

FIG. 2 illustrates a flow diagram of another exemplary method for selecting incentive target users consistent with the disclosed embodiments. As shown in FIG. 2, the method for selecting incentive target users includes the following steps.

Step 201: a server configures multiple incentive conditions based on preset rules.

Step 202: the server selects incentive conditions from multiple incentive conditions based on a first configuration instruction and forms one incentive set by performing logical combinations of the selected incentive conditions. The server repeatedly performs the steps of selecting the incentive conditions and forming one incentive set until multiple incentive sets are formed.

The incentive conditions that are selected each time when repeatedly performing the above step might not be exactly the same as the incentive conditions that are selected in any of the previous selections.

That is, every time the incentive conditions that are selected are not exactly the same as the incentive conditions selected in any previous selection. The selected incentive conditions may be partially same as a previous selection, or may be completely different from the incentive conditions in a previous selection.

For example, the preset incentive conditions include incentive condition 1, incentive condition 2, incentive condition 3, incentive condition 4, incentive condition 5 and incentive condition 6. In Step 202, the server may select incentive condition 1, incentive condition 2, and incentive condition 3 at the first time. Then the server may select incentive condition 1 and incentive condition 2, or incentive condition 4, incentive condition 5 and incentive condition 6 at the second time. The server may select incentive condition 3, incentive condition 4 and incentive condition 5 at the third time.

Optionally, when the at least one incentive set refers to one incentive set, in Step 202, the server needs to perform the steps of selecting the incentive conditions and forming one incentive set only once. When the at least one incentive set refers to N incentive sets, in Step 202, the server needs to perform the steps of selecting the incentive conditions and forming one incentive set N times, where N is an integer greater than zero.

As used herein, in Step 202, the step that the server selects the incentive conditions from multiple incentive conditions and forms one incentive set by performing a logical combination of the selected incentive conditions may include the following operations. The server selects the incentive conditions from multiple incentive conditions and forms an incentive set by performing a logical AND operation on the selected incentive conditions.

If the selected incentive conditions include incentive condition 1, incentive condition 2 and incentive condition 3, the incentive set is the incentive condition 1 AND incentive condition 2 AND incentive condition 3, where AND is the logical AND operation. Thus, a relationship among the incentive conditions included in any obtained incentive set is the logical AND operation. That is, when user information meets all incentive conditions included in any obtained incentive set, the user is selected as an incentive target user.

Step 203: the server selects incentive sets from multiple incentive sets based on a second configuration instruction and forms an incentive program by performing a logical combination of the selected incentive sets. Optionally, when user information meets all incentive conditions included in any incentive set of the incentive program, users are considered as incentive target users.

That is, in Step 203, the server may perform a logical OR operation for the selected incentive sets to obtain an operation result as an incentive program.

If the selected incentive sets include incentive set 1, incentive set 2 and incentive set 3, the incentive program is the incentive set 1 OR incentive set 2 OR incentive set 3, where OR is the logical OR operation. Thus, when user information meets all the incentive conditions included in any incentive set of three incentive sets, the user is selected as an incentive target user. Every incentive set may correspond to a specific user group. Thus, multiple user groups can use one incentive program for selecting different incentive target users at the same time.

Step 204: the server receives user information of multiple user groups sent from a user terminal and selects the users whose information meets any incentive set included in the incentive program as incentive target users.

Further, Step 201 and Step 202 may be performed before the incentive target users are selected. The server performs Step 203 when the server selects incentive target users from the user group. In addition, after the server performs Step 203, the execution result of Step 203 may be stored by JavaScript Object Notation (JSON) format. JSON is a lightweight data-interchange format and may be easy for humans to read and write. JSON is also easy for machines to parse and generate.

That is, the incentive program generated in Step 203 is stored in JSON format or other proper format. When the server selects incentive target users from the user group, the server parses the incentive program stored in JSON format. Then, the server selects incentive target users from the participating user groups by using the parsed incentive program. When the user information meets the incentive conditions of any incentive set in the parsed incentive program, the user is selected as an incentive target user.

Optionally, when the user group changes, after Step 202, the method may further include the following operations. The server modifies the incentive sets included in the incentive program.

In Step 204, the server may receive user information of multiple user groups sent from a user terminal and selects the users whose information meets any incentive set included in the modified incentive program as the incentive target users.

Optionally, the modification of incentive sets included in the incentive program may include the following two modifications. The server may modify the number of incentive sets included in the incentive program. That is, the server may delete and/or add the incentive sets included in the incentive program. The server may also modify the number of the incentive conditions included in the incentive sets of the incentive program. That is, the server may delete and/or add the incentive conditions included in the incentive sets of the incentive program.

Optionally, after the server performs Step 202, the method may further include the following operations.

Based on a third configuration instruction, multiple incentive subsets are formed by performing logical combinations on multiple incentive conditions included in one incentive set from multiple incentive sets, where the incentive conditions included in each incentive subset are part or all of the incentive conditions included in the incentive set, and the incentive conditions included in the different incentive subsets are not exactly the same.

The server selects incentive subsets from multiple incentive subsets based on a fourth configuration instruction and forms an incentive subprogram by performing a logical combination of the selected incentive subsets.

Based on user information of multiple user groups, the server selects users whose information meets any incentive subset included in the incentive subprogram as incentive target users.

Thus, multiple incentive subsets may be formed in a single incentive set, the incentive subprograms for multiple incentive sets can be generated based on the above steps, and the incentive subsets may correspond to different incentive subprograms. The user group may be selected multiple times using the multiple incentive subprograms for incentive target users.

Optionally, the incentive conditions included in the incentive subset of the incentive set belong to the incentive conditions included in the incentive set. The incentive conditions included in any incentive subset of the incentive set may be one, several or all of the incentive conditions included in the incentive set. For example, when the incentive set includes incentive condition 1, incentive condition 2, and incentive condition 3, an incentive subset of the incentive set may include only incentive condition 1; an incentive subset of the incentive set may also include incentive condition 1 and incentive condition 2; an incentive subset of the incentive set may also include incentive condition 2 and incentive condition 3; or an incentive subset of the incentive set may also include incentive condition 1, incentive condition 2 and incentive condition 3. The relationship among the incentive conditions included in every incentive subset may be a logical AND operation. That is, if the user meets all the incentive conditions included in the incentive subset, the user meets the incentive subset.

Optionally, the incentive subprogram is the result of a logical OR operation for the incentive subsets of the incentive set. That is, as long as the user information meets any incentive subset of the incentive set in the above incentive subprogram, the user is selected as the incentive target user. If user information meets any incentive subset of any incentive subprogram, the user is selected as the incentive target user.

Optionally, every incentive set may also generate the incentive subsets by the above method, and an incentive subprogram may be generated corresponding to every incentive subset. Thus, the incentive target users may be selected multiple times from the user group.

Thus, the server selects the incentive target users multiple times from the user group. That is, Step 204 is a selection of incentive target users, and the incentive subprogram is also a selection of incentive target users.

Further, the configuration instruction, such as a first configuration instruction, a second configuration instruction, a third configuration instruction and a fourth configuration instruction can be a configuration instruction received from the user input. The configuration instruction can also be the configuration instruction received from other devices, which are not limited herein.

Optionally or additionally, Step 202 may include the following steps.

Step 1: the server displays at least one select box for the user to select the incentive conditions, where each select box includes multiple preset incentive conditions.

Step 2: the server receives at least one operation for selecting the incentive conditions from user input, where every operation corresponds to one select box.

Step 3: the server selects one incentive condition from every select box, respectively.

Step 4: the server forms an incentive set by performing a logical combination of the incentive conditions selected from each select box.

Thus, the server only needs to receive a few very simple operations inputted by the user (i.e., operator, manager, programmer, etc.) to generate an incentive set. Compared to other approaches requiring network technicians to rewrite codes to generate an incentive program, the method is substantially simple and fast. In addition, the method needs not to be operated by professional personnel.

It should be noted that the incentive set described in the disclosed embodiments may be a complete incentive program that is the same as the incentive program described in the background section.

Optionally, when the server needs to generate multiple incentive sets, the server may repeat the above steps. The incentive conditions included in the newly generated incentive set every time are not identical to the incentive conditions included in the previously generated incentive sets. That is, the user operation information received every time when performing the above steps is not identical.

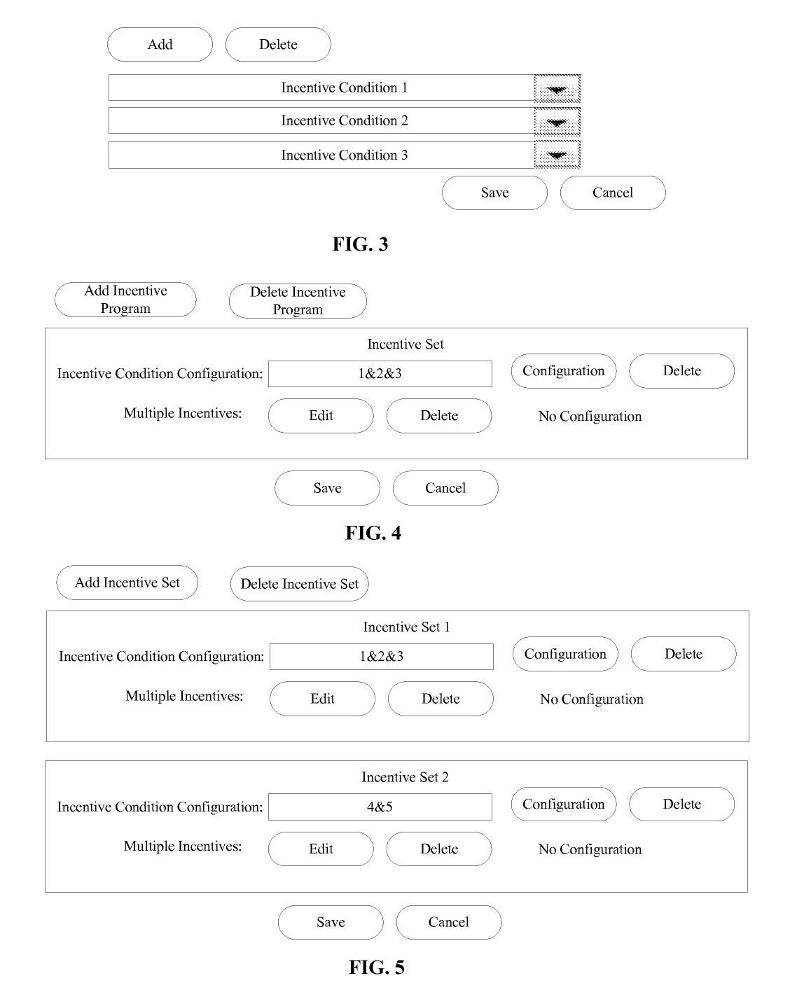

FIG. 3 illustrates a schematic diagram of an exemplary select box consistent with the disclosed embodiments. As shown in FIG. 3, the server receives the user operation information to select one incentive condition from every select box. That is, incentive conditions selected by the user are incentive condition 1, incentive condition 2 and incentive condition 3. Thus, the generated incentive set is incentive condition 1, incentive condition 2 and incentive condition 3. The relationship among these three incentive conditions may be a logic AND operation. That is, for the incentive set, only the users whose information meets all three incentive conditions are selected as incentive target users.

Optional, after server performs Step 4 above, the method may also include the following steps:

Step 5: the server displays an edit box for the user to configure incentive subset (e.g., the edit box shown in FIG. 4).

Step 6: when the server receives the user input that selects at least one incentive condition from multiple incentive conditions selected from Step 3, based on the operation information, the server selects at least one incentive condition from multiple incentive conditions selected from Step 3.

Step 7: the server forms an incentive subset by a logic combination of the at least one incentive condition selected from Step 6.

Optionally, the server can configure an incentive subset in an incentive set by performing Step 5, Step 6 and Step 7. When Step 5, Step 6 and Step 7 are performed at least once, the server can configure at least one incentive subset in an incentive set. That is, the server can configure the incentive subset of one or more incentive sets of the at least one incentive set.

FIG. 4 illustrates a schematic diagram of an exemplary edit box consistent with the disclosed embodiments. As shown in FIG. 4, an edit box with the “Edit” character is displayed for a user. When the incentive conditions selected by Step 3 are incentive condition 1, incentive condition 2 and incentive condition 3, the server receives the operation information from user input in Step 6 that selects at least one incentive condition from these three incentive conditions. For example, the server selects incentive condition 1 and incentive condition 2. Then the server combines incentive condition 1 and incentive condition 2 into one incentive subset. Specifically, the incentive condition 1 and the incentive condition 2 perform a logical AND operation, and the operation result is used as one incentive subset.

Alternatively, when the server needs to generate incentive program including multiple incentive sets (i.e., the at least one incentive set in Step 202 is multiple incentive sets), the method can repeat the above Step 1, Step 2, Step 3 and Step 4 to generate multiple incentive sets. Every time the server performs these steps, the selected incentive conditions are not exactly the same as the previously selected incentive conditions. FIG. 5 illustrates a schematic diagram of another exemplary edit box consistent with the disclosed embodiments. As shown in FIG. 5, an incentive set 1 and an incentive set 2 are generated, where the incentive set 1 includes incentive condition 1, incentive condition 2 and incentive condition 3; and the incentive set 2 includes incentive condition 4 and incentive condition 5.

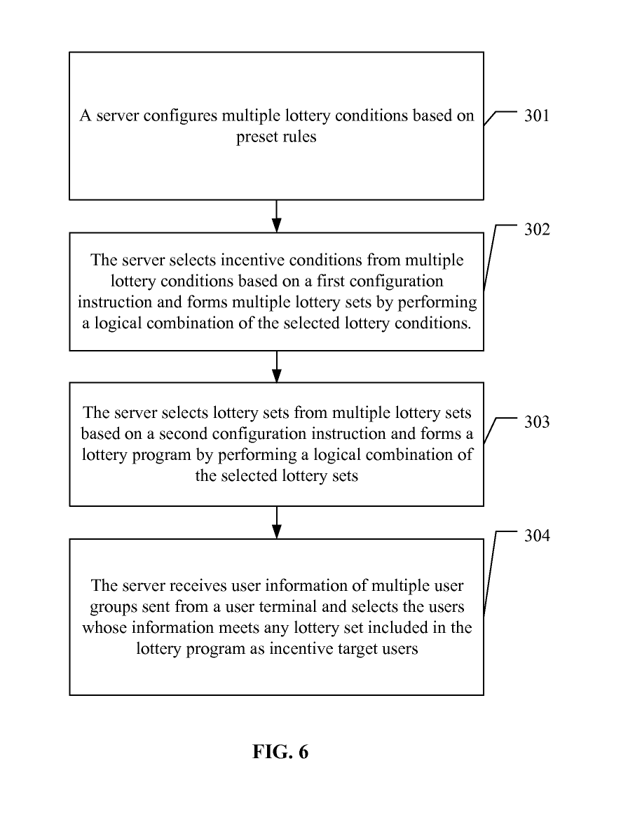

FIG. 6 illustrates an exemplary method for selecting incentive target users for a particular application (e.g., lottery) consistent with the disclosed embodiments. As shown in FIG. 6, the method includes the following steps.

Step 301: a server configures multiple lottery conditions based on preset rules.

Step 302: the server selects incentive conditions from multiple lottery conditions based on a first configuration instruction and forms multiple lottery sets by performing a logical combination of the selected lottery conditions.

Optionally, a lottery set can be considered as a lottery program that is specific to a specific user group. That is, for any user of the user group, when the user information meets the lottery conditions included in the lottery set, the user is selected as a winning user.

Optionally, the server forms multiple lottery sets by performing a logical combination of the selected lottery conditions. The logical combination may be a logical AND operation for the selected lottery conditions. A logical AND operation result is selected as a lottery set. That is, when the user information meets all lottery conditions included in the lottery set, the user is selected as a winning user.

Step 303: the server selects lottery sets from multiple lottery sets based on a second configuration instruction and forms a lottery program by performing a logical combination of the selected lottery sets.

Optionally, the selected lottery sets may be multiple lottery sets. That is, the lottery program includes multiple lottery sets. A lottery set is specific to a user group. That is, for any user of the user group, when the user information meets any of the lottery sets included in the lottery program, the user is selected as a winning user. Thus, the lottery program may be used for the lottery of multiple user groups.

Optionally, the server forms a lottery program by performing a logical combination of the selected lottery sets. The logical combination may be a logical OR operation for the selected lottery sets. A logical OR operation result is selected as a lottery program. That is, when the user information meets any lottery set included in the lottery program, the user is selected as a winning user.

Step 304: the server receives user information of multiple user groups sent from a user terminal and selects the users whose information meets any lottery set included in the lottery program as incentive target users.

Thus, one lottery program may be fit for multiple user groups. It should be noted that, the application described in FIG. 6 is only an optional application for the method for selecting incentive target users. That is, the lottery program in this example is only an application for the method for selecting incentive target users. The method for selecting incentive target users may also be applied to other applications.

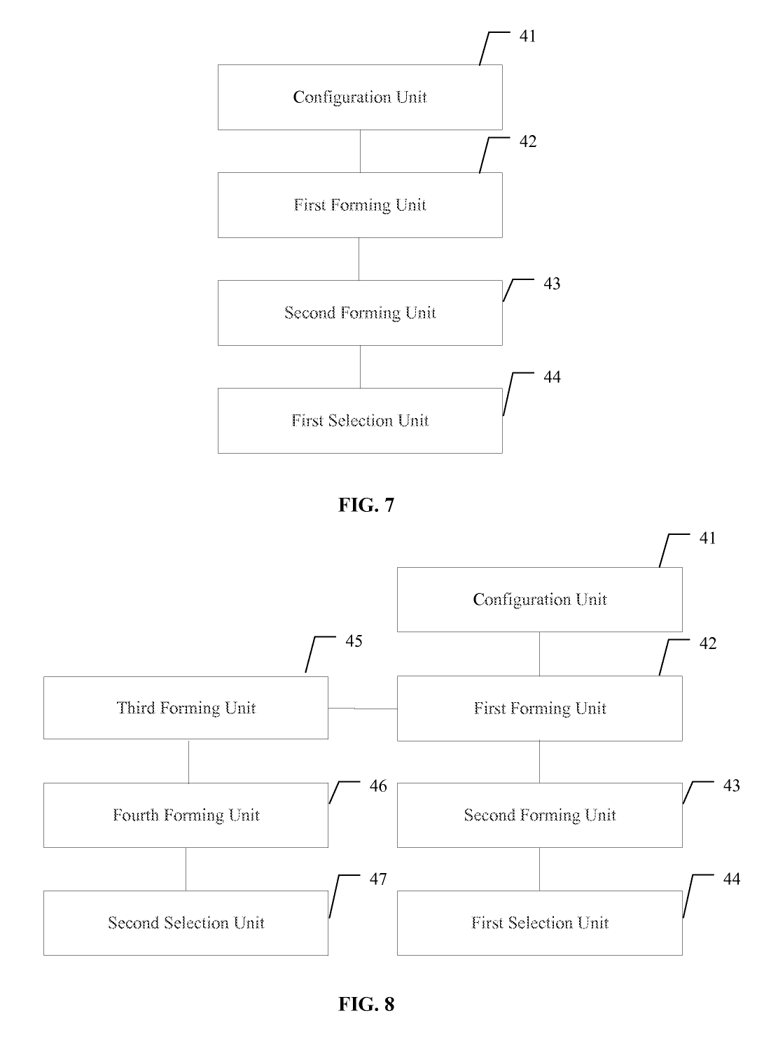

Consistently, FIG. 7 illustrates a structure diagram of an exemplary server consistent with the disclosed embodiments. As shown in FIG. 7, the server includes a configuration unit 41, a first forming unit 42, a second forming unit 43 and a first selection unit 44.

The configuration unit 41 is configured to configure multiple incentive conditions based on preset rules. The first forming unit 42 is configured to select incentive conditions from multiple incentive conditions based on a first configuration instruction and to form multiple incentive sets by performing a logical combination of the selected incentive conditions.

Optionally, any above incentive set may be considered as a complete incentive program. If user information meets the incentive conditions included in any incentive set, the user is selected as an incentive target user. At the same time, every incentive set is specific to one user group.

The second forming unit 43 is configured to select incentive sets from multiple incentive sets based on a second configuration instruction and to form an incentive program by performing a logical combination of the selected incentive sets.

The first selection unit 44 is configured to receive user information of multiple user groups sent from a user terminal and to select the users whose information meets the incentive conditions included in any incentive set as incentive target users.

Optionally, at least one incentive set forms an incentive program. The incentive program may be used for multiple user groups to select users whose information meets the incentive conditions included in any incentive set as incentive target users. The selected users may be one or more.

Optionally, the second forming unit 43 is also configured to select incentive sets from multiple incentive sets based on a second configuration instruction and to form an incentive program by performing a logical OR operation of the selected incentive sets.

Optionally, the first forming unit 42 is also configured to select incentive conditions from multiple incentive conditions based on a first configuration instruction and to form multiple incentive sets by performing a logical combination of the selected incentive conditions. The first forming unit 42 repeatedly performs the step that selects the incentive conditions from multiple incentive conditions and forms multiple incentive sets by performing a logical combination of the selected incentive conditions until multiple incentive sets are formed.

The incentive conditions that are selected each time by repeatedly performing the above step are not exactly the same as the incentive conditions that are selected in any of the previous selections.

Optionally, the first forming unit 42 is also configured to select incentive conditions from multiple incentive conditions and to form an incentive set by performing a logical AND operation of the selected incentive conditions. As used herein, only one incentive set is formed herein. The first forming unit 42 may also form multiple incentive sets by performing the above step multiple times.

FIG. 8 illustrates a structure diagram of another exemplary server consistent with the disclosed embodiments. The server includes a configuration unit 41, a first forming unit 42, a second forming unit 43, a first selection unit 44, a third forming unit 45, a fourth forming unit 46 and a second selection unit 47. The configuration unit 41, the first forming unit 42, the second forming unit 43 and the first selection unit 44 are the same as those units described in FIG. 7, the descriptions of which are not repeated herein.

The third forming unit 45 is configured to, based on a third configuration instruction, form multiple incentive subsets by performing a logical combination of multiple incentive conditions included in one incentive set from multiple incentive sets, where the incentive conditions included in each incentive subset are part or all of the incentive conditions included in the incentive set, and incentive conditions included in the different incentive subsets are not exactly the same.

The fourth forming unit 46 is configured to select incentive subsets from multiple incentive subsets based on a fourth configuration instruction and to form an incentive subprogram by performing a logical combination of the selected incentive subsets.

The second selection unit 47 is configured to, based on user information of multiple user groups, select users whose information meets any incentive subset included in the incentive subprogram as incentive target users. Thus, the server can select the incentive target users multiple times from the user group.

Accordingly, a server configures multiple incentive conditions based on preset rules. The server selects incentive conditions from multiple incentive conditions based on a first configuration instruction and forms multiple incentive sets by performing a logical combination of the selected incentive conditions. The server selects incentive sets from multiple incentive sets based on a second configuration instruction and forms an incentive program by performing a logical combination of the selected incentive sets. The server receives user information of multiple user groups sent from a user terminal and selects the users whose information meets any incentive set included in the incentive program as incentive target users. Compared to other approaches requiring network technicians to rewrite codes to generate an incentive program, the disclosed methods and systems can reduce incentive systems generation cycle and keep implementation cost low.

Those skilled in the art should understand that all or part of the steps in the above method may be executed by relevant hardware instructed by a program, and the program may be stored in a computer-readable storage medium such as a Read Only Memory (ROM), Random Access Memory (RAM), a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and apparatus for selecting incentive target users, a server configures multiple incentive conditions based on preset rules. The server selects incentive conditions from multiple incentive conditions based on a first configuration instruction and forms multiple incentive sets by performing a logical combination of the selected incentive conditions. The server selects incentive sets from multiple incentive sets based on a second configuration instruction and forms an incentive program by performing a logical combination of the selected incentive sets. The server receives user information of multiple user groups sent from a user terminal and selects the users whose information meets any incentive set included in the incentive program as incentive target users. Compared to other approaches requiring network technicians to rewrite codes to generate an incentive program, the disclosed methods and systems can reduce incentive systems generation cycle, improve efficiency for selecting incentive target users, and keep implementation cost low.

What is claimed is:

1. A method for selecting incentive target users, comprising:
configuring, by a server, multiple incentive conditions based on preset rules;
selecting, by the server, incentive conditions from multiple incentive conditions based on a first configuration instruction;
forming, by the server, multiple incentive sets by performing a logical combination on the selected incentive conditions;
selecting, by the server, incentive sets from multiple incentive sets based on a second configuration instruction;
forming, by the server, an incentive program by performing a logical combination on the selected incentive sets;
receiving, by the server, user information of multiple user groups sent from a user terminal; and
selecting, by the server, one or more users whose information meets at least one incentive set included in the incentive program as incentive target users.

2. The method according to claim 1, wherein forming an incentive program by performing a logical combination of the selected incentive sets further includes:
performing, by the server, a logical OR operation for the selected incentive sets to obtain an operation result as an incentive program.

3. The method according to claim 2, wherein selecting incentive conditions from multiple incentive conditions based on a first configuration instruction and forming multiple incentive sets by performing a logical combination of the selected incentive conditions further includes:
selecting, by the server, incentive conditions from multiple incentive conditions based on a first configuration instruction;
forming, by the server, one incentive set by performing a logical combination of the selected incentive conditions; and
performing repeatedly, by the server, the steps of selecting the incentive conditions and forming one incentive set until multiple incentive sets are formed, wherein:
the incentive conditions that are selected each time by repeatedly performing the step are not exactly the same as the incentive conditions that are selected in any of the previous selections.

4. The method according to claim 3, wherein selecting incentive conditions from multiple incentive conditions based on a first configuration instruction and forming one incentive set by performing a logical combination of the selected incentive conditions further includes:
selecting, by the server, the incentive conditions from multiple incentive conditions; and
forming, by the server, an incentive set by performing a logical AND operation for the selected incentive conditions.

5. The method according to claim 3, after forming multiple incentive sets, further including:
forming, by the server, multiple incentive subsets by performing a logical combination of multiple incentive conditions included in one incentive set from multiple incentive sets based on a third configuration instruction, wherein the incentive conditions included in each incentive subset are part or all of the incentive conditions included in the incentive set; and the incentive conditions included in the different incentive subsets are not exactly the same;
selecting, by the server, incentive subsets from multiple incentive subsets based on a fourth configuration instruction;
forming, by the server, an incentive subprogram by performing a logical combination of the selected incentive subsets; and
selecting, by the server, users whose information meets at least one incentive subset included in the incentive subprogram as incentive target users.

6. The method according to claim 5, after forming an incentive program by performing a logical combination of the selected incentive sets, further including:
storing the incentive program by JavaScript Object Notation (JSON) format.

7. The method according to claim 6, wherein:
a total number of incentive conditions included in any incentive set is one or more.

8. The method according to claim 6, wherein:
at least one incentive set forms an incentive program.

9. A server for selecting incentive target users, comprising:
a configuration unit configured to configure multiple incentive conditions based on preset rules;
a first forming unit configured to select incentive conditions from multiple incentive conditions based on a first configuration instruction and to form multiple incentive sets by performing a logical combination of the selected incentive conditions;
a second forming unit configured to select incentive sets from multiple incentive sets based on a second configuration instruction and to form an incentive program by performing a logical combination of the selected incentive sets; and
a first selection unit configured to receive user information of multiple user groups sent from a user terminal and to select the users whose information meets the incentive conditions included in at least one incentive set as incentive target users.

10. The server according to claim 9, wherein the second forming unit is further configured to:
select incentive sets from multiple incentive sets based on a second configuration instruction; and
form an incentive program by performing a logical OR operation for the selected incentive sets.

11. The server according to claim 10, wherein the first forming unit is further configured to:
select incentive conditions from multiple incentive conditions based on a first configuration instruction;
form one incentive set by performing a logical combination of the selected incentive conditions; and
perform repeatedly the steps of selecting the incentive conditions and forming one incentive set until multiple incentive sets are formed, wherein:
the incentive conditions that are selected each time by repeatedly performing the step are not exactly the same as the incentive conditions that are selected in any of the previous selections.

12. The server according to claim 11, wherein the first forming unit is further configured to:
select the incentive conditions from multiple incentive conditions; and
form an incentive set by performing a logical AND operation for the selected incentive conditions.

13. The server according to claim 11, wherein the server further includes:
a third forming unit configured to, based on a third configuration instruction, form multiple incentive subsets by performing a logical combination of multiple incentive conditions included in one incentive set from multiple incentive sets, wherein the incentive conditions included in each incentive subset are part or all of the incentive conditions included in the incentive set; and the incentive conditions included in the different incentive subsets are not exactly the same;
a fourth forming unit configured to select incentive subsets from multiple incentive subsets based on a fourth configuration instruction and to form an incentive subprogram by performing a logical combination of the selected incentive subsets; and
a second selection unit configured to, based on user information of multiple user groups, select users whose information meets at least one incentive subset included in the incentive subprogram as incentive target users.

14. The server according to claim 13, after forming an incentive program by performing a logical combination of the selected incentive sets, further including:
storing the incentive program by JavaScript Object Notation (JSON) format.

15. The server according to claim 14, wherein:
a total number of incentive conditions included in any incentive set is one or more.

16. The server according to claim 14, wherein:
at least one incentive set forms an incentive program.
